(19) United States
(12) Patent Application Publication
(10) Pub. No.: US 2006/0007322 A1
(43) Pub. Date: Jan. 12, 2006

(54) Image capturing apparatus and method of acquiring image

(75) Inventors: Kenji Nakamura, Takatsuki-shi (JP); Masahiro Kitamura, Osaka-shi (JP); Shinichi Fujii, Osaka-shi (JP); Yasuhiro Kingetsu, Sakai-shi (JP); Dai Shintani, Izumi-shi (JP); Tsutomu Honda, Sakai-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA PHOTO IMAGING, INC.

(21) Appl. No.: 11/053,467

(22) Filed: Feb. 8, 2005

(30) Foreign Application Priority Data
Jul. 9, 2004 (JP) P2004-203060

(51) Int. Cl. H04N 5/228

(52) U.S. Cl. 348/222.1

(57) ABSTRACT

In a photographing condition specification mode, a user manipulates or presses a rear manipulation part to select at least one variable condition item from among photographing condition items: “focusing,” “exposure,” “white balance” and the like. In an actual photographing operation, a plurality of images corresponding to respective stepwise different photographing conditions regarding the variable condition item are acquired in time sequence and temporarily stored in a memory. Then, an evaluation area is specified in accordance with user's manipulation or press of the rear manipulation part. The single image that most satisfies an appropriate condition regarding the variable condition item is extracted from among the images temporarily stored in the memory, and is stored in a memory card. The remaining images are, for example, deleted.

This application is based on application No. JP2004-203060 filed in Japan, the contents of which are hereby incorporated by reference.

### BACKGROUND OF THE INVENTION

1. Field of the Invention

The present invention relates to a technique for acquiring an image.

2. Description of the Background Art

A typical image capturing apparatus is capable of acquiring images in accordance with photographing scenes by appropriately effecting autofocus (AF) control, automatic exposure (AE) control, auto white balance (AWB) control, and the like.

For accurate photographing of a subject on every occasion regardless of the situation of the subject, a camera has been proposed which detects the situation of the subject based on a moving image from an image sensor to change the number of frames to be outputted per unit time from the image sensor (as disclosed in, for example, Japanese Patent Application Laid-Open No. 2001-358984). This reference makes no disclosure of focusing. However, a typical image capturing apparatus captures an image after performing an AF operation (one-shot AF operation) which drives a focusing lens to a position where a main subject is in focus.

The one-shot AF operation will be briefly described.

First, an objective area (or evaluation area) in which a contrast value (or focusing evaluation value) for evaluation of the status of focusing is to be calculated is defined in a central position or in any user-defined position of a live view image based on an image signal outputted from a CCD imaging device. As shown in FIG. 15, for example, the live view image and a box Ae indicating the current position of the evaluation area are displayed in superimposed relation on an LCD screen provided in the image capturing apparatus prior to actual photographing.

FIG. 16 is an operational flow chart showing the one-shot AF operation. With the live view image displayed on the LCD screen, the one-shot AF operation starts in response to a press of a shutter release button by a user.

After the one-shot AF operation starts, a driving direction of the focusing lens in which the focusing evaluation value calculated for the evaluation area increases is determined by slightly driving the focusing lens from its initial position (in Step S101). Next, while the focusing lens is driven stepwise at a predetermined spacing in the driving direction determined in Step S101, images corresponding to the respective positions (lens positions) of the focusing lens are acquired, and the focusing evaluation values are calculated, based on the respective image data in the evaluation area. The focusing lens continues to be driven until the focusing evaluation values begin to decrease (in Step S102). With reference to FIG. 17, when the focusing evaluation values begin to decrease, driving the focusing lens is stopped, and a lens position (or in-focus lens position) corresponding to the maximum focusing evaluation value is calculated by a quadratic interpolation approximation calculation (or calculation based on quadratic curve approximation) using the maximum focusing evaluation value Yn, its adjacent focusing evaluation values Yn−1, Yn+1, and lens positions (Xn−1, Xn, Xn+1) corresponding to the three focusing evaluation values, respectively (in Step S103). The focusing lens is then driven to the in-focus lens position calculated in Step S103 (in Step S104). Then, the one-shot AF operation is terminated.

However, if the evaluation area fixed at the center of the image is used during the above-mentioned one-shot AF operation, only a subject near the center of the image is brought into focus, and it is difficult to acquire an image (or in-focus image) wherein the subject is in focus within a desired composition. If the evaluation area is movable by the manipulation of the user, moving the evaluation area to a desired position prior to actual photographing requires a complicated manipulation. Such a complicated manipulation prior to the actual photographing is a deterrent to photographing, and hinders the user from concentrating his/her energies on photographing, resulting in a problem such that the user fails to press the shutter release button at a desired moment, and the like.

Such a problem is not limited to the AF control, but is common to general control processes relating to various photographing conditions, such as the exposure control and the white balance control. Specifically, when automatic exposure control is adopted, for example, which adjusts the average brightness of the entire image at a fixed level, a main subject contained in the image is too dark or too bright in some cases. Conversely, the user must perform complicated manipulations prior to photographing when setting the brightness of the main subject at a desired level by the various manipulations.

### SUMMARY OF THE INVENTION

The present invention is intended for an image capturing apparatus.

According to the present invention, the image capturing apparatus comprises: an imaging part for acquiring an image of a subject; a photographing control part for causing the imaging part to perform a photographing operation for acquiring a plurality of images corresponding to a plurality of photographing conditions, respectively, while successively adopting the plurality of photographing conditions in time sequence, the plurality of photographing conditions being stepwise different from each other regarding a predetermined photographing condition item; a specification part for specifying a position of an evaluation area for the plurality of images in response to a manipulation of a user after the photographing operation; and an extraction part for extracting one of the plurality of images which most satisfies a predetermined condition regarding the predetermined photographing condition item for the evaluation area.

The image capturing apparatus eliminates the need for complicated manipulations prior to photographing, and easily provides a desired image. In other words, a user need not turn his/her mind to the setting of the photographing conditions during the photographing, and can make specifications relating to the photographing conditions after the photographing. This reduces mistakes in photographing, and improves the ease-of-use of the image capturing apparatus.

According to another aspect of the present invention, the predetermined photographing condition item includes at least one item among focusing, exposure and white balance, and the extraction part includes an evaluation value calculation part for calculating at least one evaluation value for the evaluation area among a focusing evaluation value, an exposure evaluation value and a white balance evaluation value for the evaluation area in each of the plurality of images, and a part for extracting the one of the plurality of images, based on the evaluation value calculated by the evaluation value calculation part.

The image capturing apparatus can easily acquire an image satisfying a desired condition about focusing, exposure, white balance, and the like.

The present invention is also intended for a method of acquiring an image.

It is therefore an object of the present invention to provide an image capturing technique which eliminates the need for complicated manipulations prior to photographing, and which is capable of easily providing a desired image.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing an external appearance of an image capturing apparatus according to a preferred embodiment of the present invention;

FIG. 2 is a rear view showing the external appearance of the image capturing apparatus according to the preferred embodiment of the present invention;

FIG. 3 is a block diagram showing a functional construction of the image capturing apparatus according to the preferred embodiment of the present invention;

FIG. 4 illustrates a screen for selection of variable condition items;

FIG. 5 is a flow chart illustrating an operation in a photographing condition specification mode;

FIG. 6 illustrates images as temporarily stored in a memory;

FIG. 7 is a timing diagram showing an actual photographing operation in the photographing condition specification mode;

FIGS. 8 through 12 are views illustrating images captured by actual photographing in the photographing condition specification mode;

FIG. 13 is a view illustrating a screen for specification of an evaluation area;

FIG. 14 is a flow chart illustrating an operation in the photographing condition specification mode;

FIG. 15 is a view for illustrating the specification of an evaluation area;

FIG. 16 is an operational flow chart showing a one-shot AF operation; and

FIG. 17 shows a relationship between a focusing lens position and a focusing evaluation value.

### DESCRIPTION OF THE PREFERRED EMBODIMENTS

A preferred embodiment according to the present invention will now be described with reference to the drawings.

<Overview of Image Capturing Apparatus>

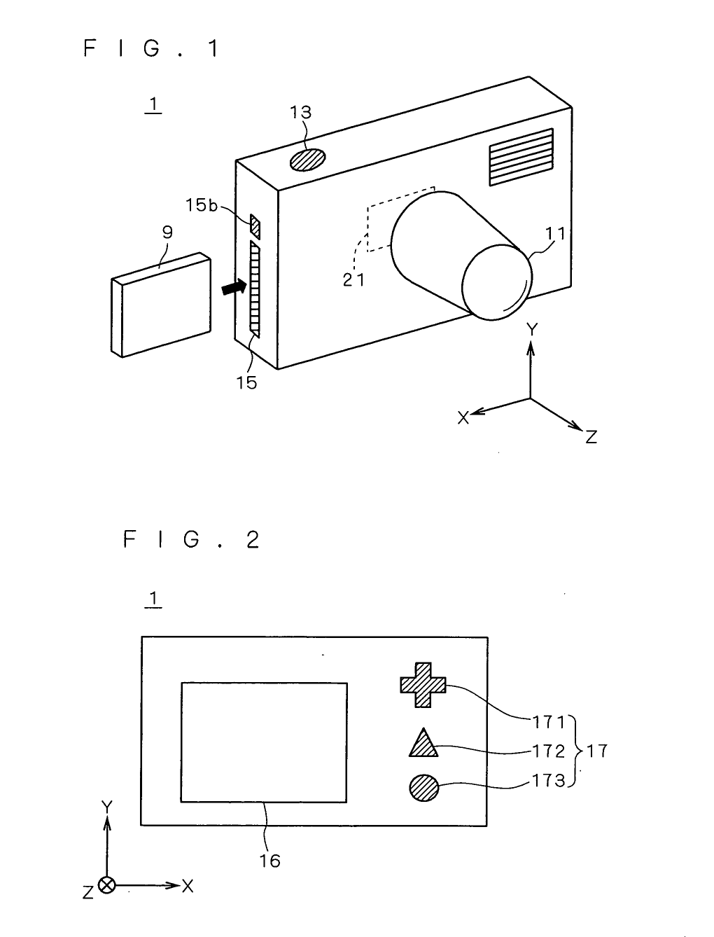

FIG. 1 is a perspective view showing an external appearance of an image capturing apparatus 1 according to the preferred embodiment of the present invention.

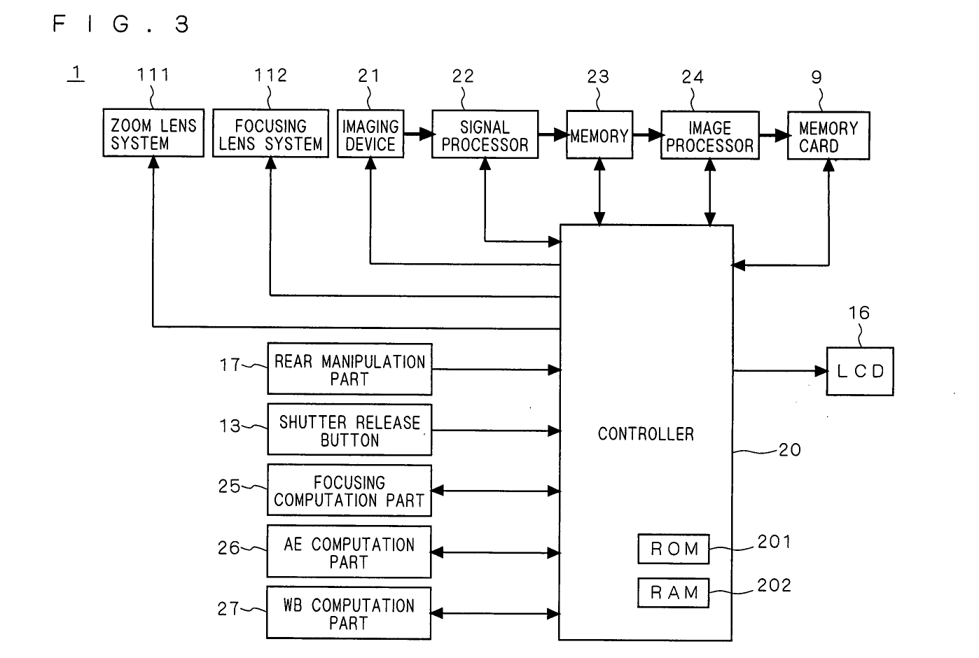

FIG. 2 is a rear view showing the external appearance of the image capturing apparatus 1. Three axes X, Y and Z orthogonal to each other are shown in FIGS. 1 and 2 for the purpose of clarifying an orientational relationship.

The image capturing apparatus 1 is constructed in the form of a digital camera, and is provided with a taking lens device 11 on the front surface thereof. An imaging device 21 for converting an optical image of a subject incident thereon through the taking lens device 11 into an electrical image signal is provided behind the taking lens device 11. The imaging device 21 used in this preferred embodiment is of a CMOS type. A CCD may be used as the imaging device.

The taking lens device 11 includes a lens system drivable along an optical axis, and is constructed so that driving the lens system along the optical axis achieves the focusing of the optical image of the subject image-formed on the imaging device 21.

A shutter release button 13 is provided on the upper surface of the image capturing apparatus 1. For photographing a subject, a user presses the shutter release button 13 to provide an instruction (also referred to as a “photographing start instruction”) for causing the image capturing apparatus 1 to start an actual photographing operation.

A side surface of the image capturing apparatus 1 is formed with a card receiving slot 15 for insertion of a memory card 9 therein. The memory card 9 is a recording medium for storing therein image data obtained during the actual photographing operation caused by a press of the shutter release button 13 by the user. The side surface of the image capturing apparatus 1 is further formed with a card eject button 15b. The user can eject the memory card 9 from the card receiving slot 15 by pressing the card eject button 15b.

The rear surface of the image capturing apparatus 1 is provided with an LCD (liquid crystal display) 16, and a rear manipulation part 17. The LCD 16 functions as a display element for producing a live view display for displaying a subject in the form of a moving picture prior to actual photographing, and for displaying captured images and the like. The rear manipulation part 17 includes a cross switch 171 and buttons 172 and 173. By pressing the cross switch 171, the user can change a selection among various items on a screen displayed on the LCD 16, and achieve the increase and decrease in image magnification, and the like. By pressing the execution button 172, the user can execute various operations, the determination of the selection, and the like. By pressing the mode selection button 173, the user can make a mode selection between a plurality of modes such as a playback mode, and a recording mode including a photographing condition specification mode to be described later and a mode (also referred to as a “normal photographing mode”) in which normal photographing is carried out as with a typical digital camera.

<Functional Construction of Image Capturing Apparatus>

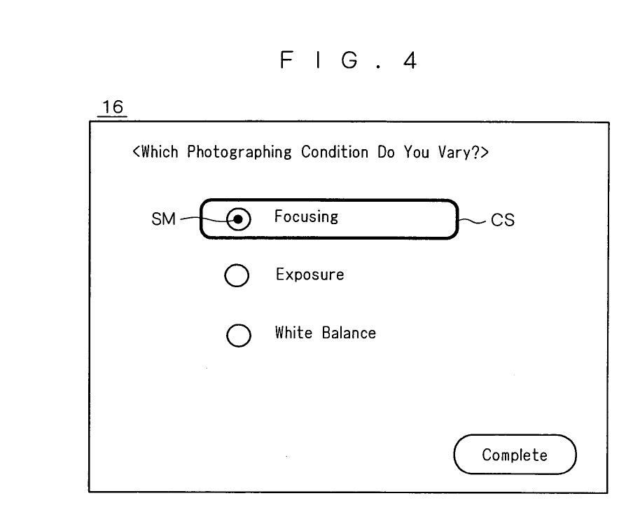

FIG. 3 is a block diagram showing a functional construction of the image capturing apparatus 1.

The taking lens device 11 includes a lens system (also referred to as a “zoom lens system”) 111 for changing the image magnification, and a lens system (also referred to as a “focusing lens system”) 112 for achieving the focusing of the image of a subject image-formed on the imaging device 21. The focusing lens system 112 is driven back and forth along the optical axis of the taking lens device 11 to allow the acquisition of in-focus images of subjects positioned at various distances.

The imaging device 21 performs a photoelectric conversion based on the image of the subject image-formed through the zoom lens system 111 and the focusing lens system 112 to generate an image signal (including signals indicating pixel values corresponding to three colors: R, G and B), thereby outputting the image signal to a signal processor 22. Thus, the image signal (also referred to simply as an “image” hereinafter) about the subject is acquired by the operation of the imaging device 21.

A driving mode (or a readout mode) of the imaging device 21 includes two modes: a draft mode and an actual photographing mode. The draft mode is a readout mode for generating a preview image for live view display prior to the photographing (or “actual photographing”) during which an image is acquired and stored in the memory card 9 and the like. The draft mode is applied during the so-called live view display. In the draft mode, the imaging device 21 is driven so as to read one out of every eight horizontal lines, for example, when reading one frame of the image signal. The actual photographing mode is a readout mode in which the image signal is read from all of the pixels of the imaging device 21 during the actual photographing.

In the photographing condition specification mode to be described later, the rate (or frame rate) at which the image signal is read from the imaging device 21 in the actual photographing mode is relatively higher than the frame rate in the draft mode. For example, the frame rate in the draft mode is 30 frames per second (30 fps) at which a display on the LCD appears to the human eye sufficiently as a moving picture, whereas the frame rate in the actual photographing mode is 300 frames per second (300 fps) which is ten times higher. In other words, one frame of the image signal is read and outputted from the imaging device 21 every 1/30 of a second in the draft mode in which the image signal is read for the live view display, whereas one frame of the image signal is read and outputted from the imaging device 21 every 1/300 of a second in the actual photographing mode.

The signal processor 22 includes a CDS (correlated double sampler), an amplifier, and an A-D converter. The image signal from the imaging device 21 is sampled in the CDS, subjected to desired amplification in the amplifier, and then converted into a digital signal in the A-D converter. The image signal (or image) outputted from the signal processor 22 is temporarily stored (or buffered) in an SDRAM (or memory) 23 in response to a DMA command from a controller 20. The image temporarily stored in the memory 23 is sent to an image processor 24, and is also sent to a focusing computation part 25, an AE computation part 26, and a WB computation part 27 as appropriate.

The focusing computation part 25 calculates, for example, the sum of the absolute values of the differences between pixel values of adjacent pixels of a partial image within an evaluation area defined in the image provided from the memory 23, to provide the calculated sum as a focusing evaluation value for evaluation of the status of focusing to the controller 20.

The AE computation part 26 calculates exposure control values (shutter speed, aperture value, gain value and the like) in accordance with the brightness (or subject brightness) of the image provided from the memory 23 to output the exposure control values to the controller 20 during the live view display. In the photographing condition specification mode, as required, the AE computation part 26 calculates, for example, the average of the pixel values of the pixels of the partial image within the evaluation area defined in the image acquired by the actual photographing operation and temporarily stored in the memory 23, to provide the calculated average as an exposure evaluation value for evaluation of the status of exposure to the controller 20. The exposure control values set in the controller 20 to be described later are adopted as those for use during the actual photographing in the photographing condition specification mode when the exposure control values are varied stepwise during the actual photographing. The exposure control values calculated in the AE computation part 26 immediately before the actual photographing are adopted when the exposure control values are not varied stepwise during the actual photographing.

The WB computation part 27 calculates a value indicating the optimized white balance (WB) of the image, based on the pixel values of the pixels of the image provided from the memory 23 to output the value as a WB setting value to the controller 20 during the live view display. Then, the controller 20 calculates a gain value (or WB gain value) for optimization of the white balance of the image, based on the WB setting value provided from the WB computation part 27. In the photographing condition specification mode, as required, the WB computation part 27 calculates, for example, the cumulative total value (or colorimetry evaluation value) Rs, Gs, Bs of the pixel values for each color R, G, B of the partial image within the evaluation area defined in the image acquired by the actual photographing operation and temporarily stored in the memory 23. The WB computation part 27 calculates a WB evaluation value (gr,gb) for evaluation of the white balance, based on the following equation:
(gr,gb)=(Rs/Gs,Bs/Gs) (1)
to provide the WB evaluation value to the controller 20. The WB gain value set in the controller 20 to be described later is adopted as that for use during the actual photographing in the photographing condition specification mode when the white balance is varied stepwise during the actual photographing. The WB gain value calculated by the WB computation part 27 and the controller 20 immediately before the actual photographing are used when the white balance is not varied stepwise during the actual photographing.

The image processor 24 performs image processing including the adjustment of the white balance based on the WB gain value, gamma correction, aperture control, and the like upon images. During the actual photographing, the image processor 24 performs a compression process on an image to be stored in the memory card 9 as appropriate, and the image subjected to the compression process is then stored in the memory card 9. During the live view display, the image outputted from the image processor 24 is converted into a size depending on the number of display pixels of the LCD 16, and is provided as a visible output from the LCD 16.

The controller 20 principally includes a CPU, a ROM 201, a RAM 202 and the like, and exercises centralized control over the components in the image capturing apparatus 1. In the controller 20, the CPU reads and executes a predetermined program stored in the ROM 201 or the like to implement various computations, control, and the like.

The operations in the photographing condition specification mode to be described later are also implemented by various functions of the controller 20. The ROM 201 stores therein a plurality of (for example, ten) stepwise different photographing conditions (parameters) for each of the items (“focusing,” “exposure” and “white balance”), the photographing conditions being varied during photographing. Specifically, for the “focusing,” the ROM 201 stores therein a plurality of positions of the focusing lens system 112 within the range of driving of the focusing lens system 112 between an extended position (also referred to as a “distal position”) and a retracted position (also referred to as a “proximal position”) along the optical axis of the focusing lens system 112. For the “exposure,” the ROM 201 stores therein a plurality of exposure control values corresponding to a range from a relatively high exposure value to a relatively low exposure value. For the “white balance,” the ROM 201 stores therein a plurality of WB gain values ranging from a WB gain value for generation of a reddish image to a WB gain value for generation of a bluish image. The items relating to the photographing conditions, such as “focusing,” “exposure” and “white balance,” are also referred to hereinafter as “photographing condition items.”

The rear manipulation part 17 sends various signals to the controller 20 in response to the press of the cross switch 171 and the buttons 172 and 173.

The shutter release button 13 is a two-position switch capable of detecting a half pressed position (S1) and a fully pressed position (S2). In the normal photographing mode, pressing the shutter release button 13 into the half pressed position (S1) during the live view display effects general autofocus control, automatic exposure control and white balance control, and subsequently pressing the shutter release button 13 into the fully pressed position (S2) effects the actual photographing operation. In the photographing condition specification mode, the shutter release button 13, upon being pressed into the fully pressed position (S2), issues the photographing start instruction indicative of the start of the actual photographing operation to the controller 20, whereby the image capturing apparatus 1 performs a series of actual photographing operations to be described later.

Description will be given on the operation of the image capturing apparatus 1 when the photographing condition specification mode is set.

<Operation in Photographing Condition Specification Mode>

The operation of the image capturing apparatus 1 in the photographing condition specification mode will be briefly described.

In the photographing condition specification mode, a user can select at least one of the photographing condition items (i.e., at least one of the items: “focusing,” “exposure” and “white balance”) regarding which the conditions are to be varied during photographing, before the actual photographing is performed. Then, photographing is performed a plurality of times while stepwise varying the photographing conditions regarding the photographing condition item (also referred to as a variable condition item) regarding which the conditions are to be varied during photographing in response to the photographing start instruction based on the user's manipulation, whereby a plurality of images corresponding to the respective photographing conditions are acquired (in the actual photographing operation). After the actual photographing operation, when the user specifies one evaluation area for the plurality of images, the single one of the images in which a partial image defined by the evaluation area most satisfies a predetermined condition regarding the variable condition item is extracted and stored in the memory card 9. The remainder of the plurality of images which are not extracted are deleted.

The operations in the photographing condition specification mode will be described in detail.

<Selection of Variable Condition Item>

FIG. 4 illustrates a screen (also referred to hereinafter as a “selection screen”) for selection of the variable condition item. When the user presses the mode selection button 173 to place the image capturing apparatus 1 in the photographing condition specification mode, the selection screen as shown in FIG. 4 is displayed on the LCD 16.

On the selection screen shown in FIG. 4 are displayed four items: three photographing condition items (“focusing,” “exposure” and “white balance”) prepared as a choice, and an item “complete” for completion of the selection of one of the photographing condition items, the four items being arranged vertically in order.

With the selection screen of FIG. 4 displayed on the LCD 16, the user presses the upper or lower button of the cross switch 171 to place a box cursor CS at one of the items: “focusing,” “exposure,” “white balance” and “complete.” When the user places the box cursor CS at any one of the items of choice and then presses the execution button 172, a mark (or selection mark) SM is added to the left of the item at which the box cursor CS is placed to indicate that the item is selected. When the user places the box cursor CS at the item “complete” and presses the execution button 172, with the selection mark SM added as appropriate, then the item to which the selection mark SM is added is selected as the variable condition item.

In response to the selection of each variable condition item, the controller 20 reads the plurality of photographing conditions corresponding to each variable condition item from the ROM 201 to the RAM 202 to set the read photographing conditions as those for use in photographing. The plurality of photographing conditions set in this process are, for example, as follows. When the variable condition item is “focusing,” the photographing conditions are the plurality of positions of the focusing lens system 112 which are stepwise different from each other by the amount of the depth of field, starting at the distal position and ending at the proximal position of the range of driving of the focusing lens system 112. When the variable condition item is “exposure,” the photographing conditions are the plurality of exposure control values corresponding to the exposure values stepwise different from each other in the range from the low exposure value to the high exposure value. When the variable condition item is “white balance,” the photographing conditions are the plurality of WB gain values stepwise different from each other in the range from the WB gain value for generation of a reddish image to the WB gain value for generation of a bluish image.

After one or more variable condition items are selected in this manner, a live view display composed of a plurality of live view images (still images) is produced on the LCD 16 for determination of the composition during the actual photographing.

<Example of Operational Flow in Photographing Condition Specification Mode>

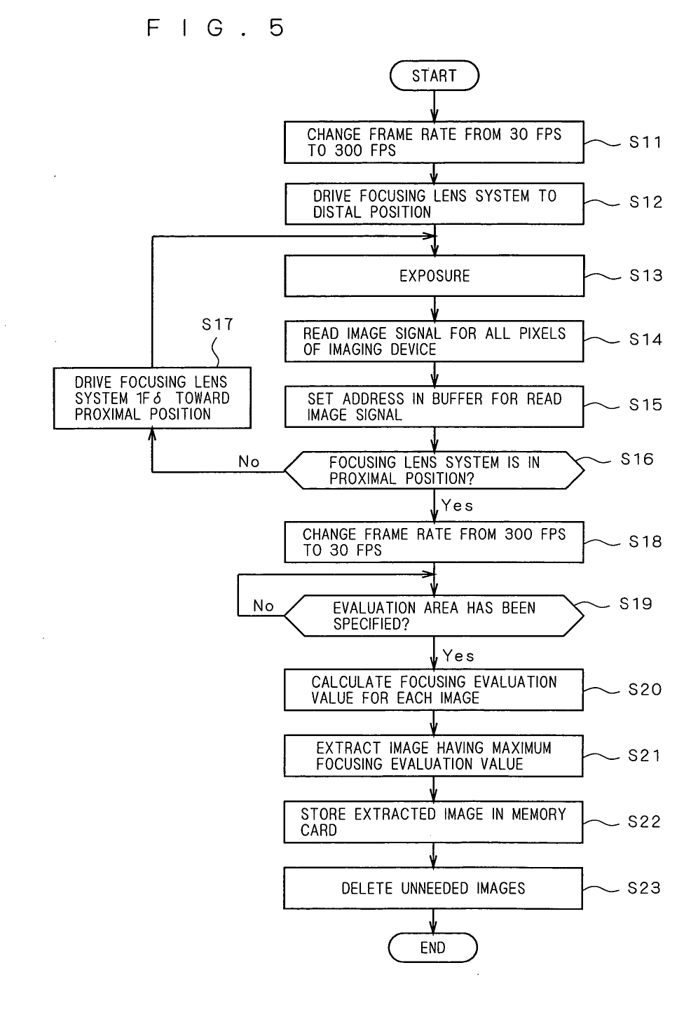

FIG. 5 is an operational flow chart illustrating the actual photographing and storage process of the image capturing apparatus 1 set in the photographing condition specification mode. The operational flow in the case where only “focusing” is selected as the variable condition item is shown in FIG. 5. This operational flow is implemented under the control of the controller 20.

As described above, when the user presses the shutter release button 13 into the half pressed position (S1) with the live view display produced on the LCD 16 after the selection of the variable condition item on the selection screen as shown in FIG. 4, the exposure control value and the WB gain value for the actual photographing are set based on a live view image. Subsequently, when the shutter release button 13 is pressed into the fully pressed position (S2), the operational flow shown in FIG. 5 starts, and the processing proceeds to Step S11 of FIG. 5.

In Step S11, the rate (frame rate) at which the image signal is read from the imaging device 21 is changed from 30 frames per second (30 fps) to 300 frames per second (300 fps), and the processing proceeds to Step S12. Specifically, in Step S11, the frame rate in the imaging device 21 is changed to a relatively higher frame rate than the frame rate used prior to the issue of the photographing start instruction in response to the press of the shutter release button 13 by the user, i.e. the photographing start instruction.

In Step S12, the focusing lens system 112 is driven along the optical axis of the taking lens device 11 to the fully extended position (or the distal position), and the processing proceeds to Step S13.

In Step S13, an exposure is performed for image-forming a subject on the imaging device 21, and the processing proceeds to Step S14.

In Step S14, an image signal for all pixels (e.g., an image signal for about three megapixels) is read from the imaging device 21, subjected to various processes, and then temporarily stored in the memory 23. Then, the processing proceeds to Step S15.

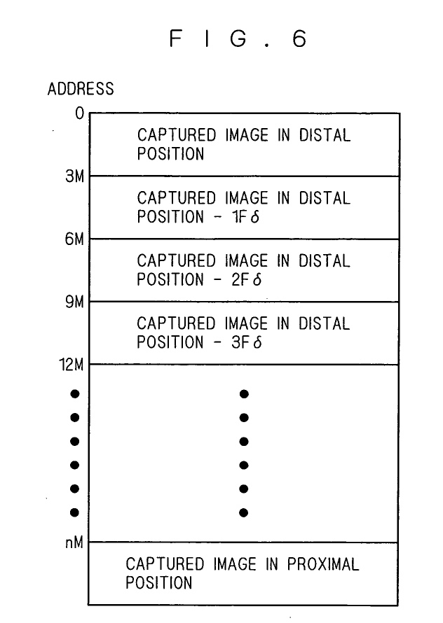

In Step S15, an address in the memory (buffer) 23 for an image signal (or image) to be acquired and temporarily stored next is set at the address subsequent to the ending address of the image temporarily stored in Step S14, as shown in FIG. 6. Then, the processing proceeds to Step S16.

In Step S16, a determination is made as to whether or not the focusing lens system 112 is in the fully retracted position (proximal position) along the optical axis of the taking lens device 11. When the focusing lens system 112 is in the proximal position in Step S16, the processing proceeds to Step S18; otherwise, the processing proceeds to Step S17.

In Step S17, the focusing lens system 112 is driven a distance corresponding to the depth of field (1 Fδ) toward the retracted position (or proximal position). Then, the processing returns to Step S13. Thus, the processes in Steps S13 to S17 are repeated until the focusing lens system 112 reaches the proximal position. In other words, while the focusing lens system 112 is moved gradually in steps each corresponding to the depth of field from the distal position to the proximal position, images corresponding to the respective positions of the focusing lens system 112 are acquired. As a result, n images or n frames (e.g., n=10) containing stepwise different in-focus subjects are temporarily stored in the memory 23.

FIG. 7 is a timing diagram showing exposure timing, image signal read timing and the timing of the driving of the focusing lens system 112 in the photographing condition specification mode. The timing diagram in the case where only “focusing” is selected as the variable condition item is illustrated in FIG. 7. The exposure timing and read timing for the live view display before and after the actual photographing are denoted by the character LV.

In the actual photographing operation in the photographing condition specification mode, the first, second, third, . . . , (n−3)th, (n−2)th, (n−1)th and n-th processes of driving the focusing lens system 112, exposures and image signal readings are executed in time sequence in response to the generation of a vertical synchronization signal (VD), as shown in FIG. 7. Because “exposure” and “white balance” are not selected as the variable condition items in this case, the exposure control value and the WB gain value during the actual photographing operation are constant values set immediately before the actual photographing operation (when the shutter release button 13 is in the half pressed position (S1)).

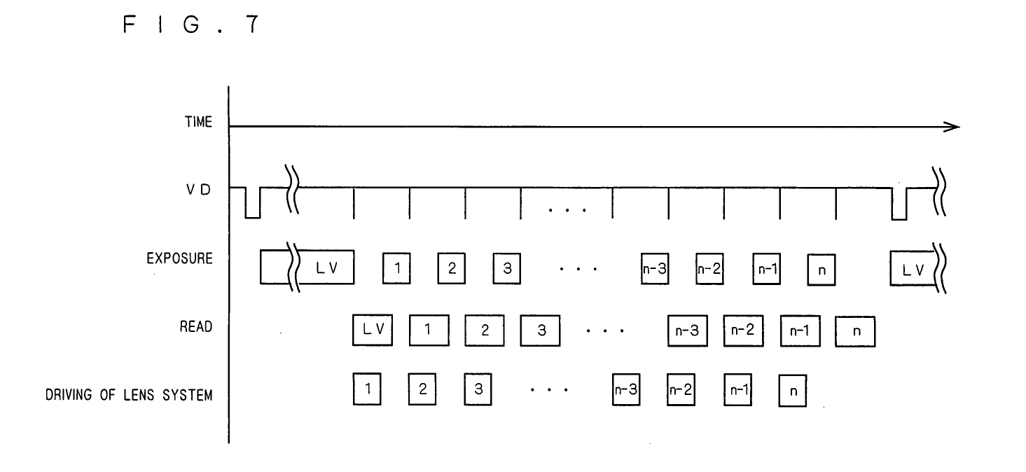

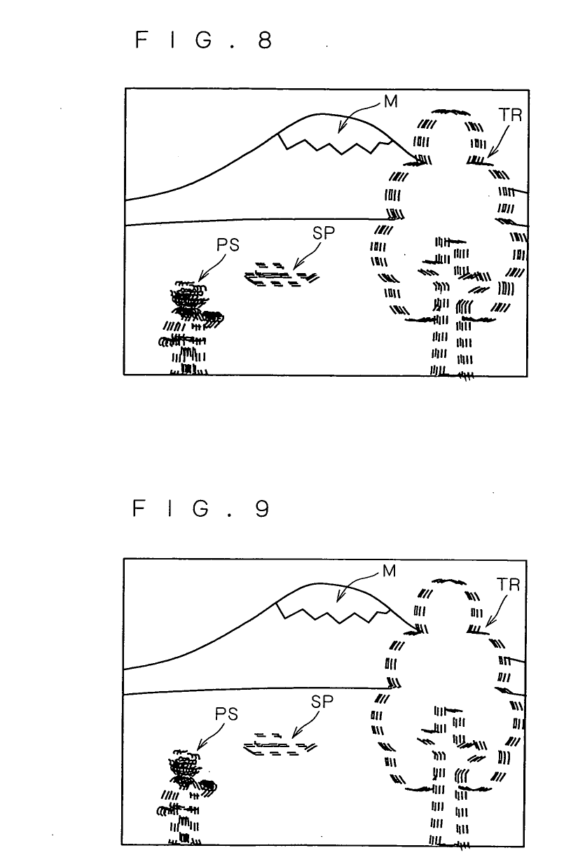

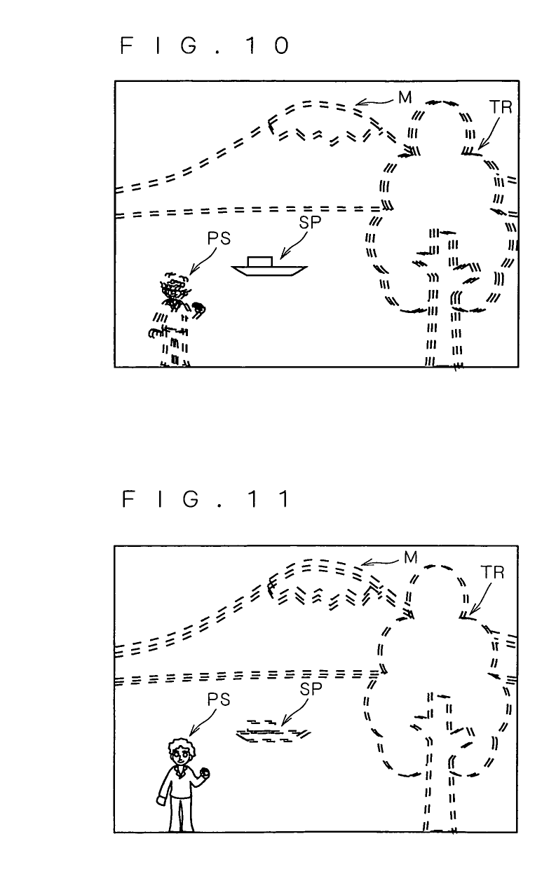

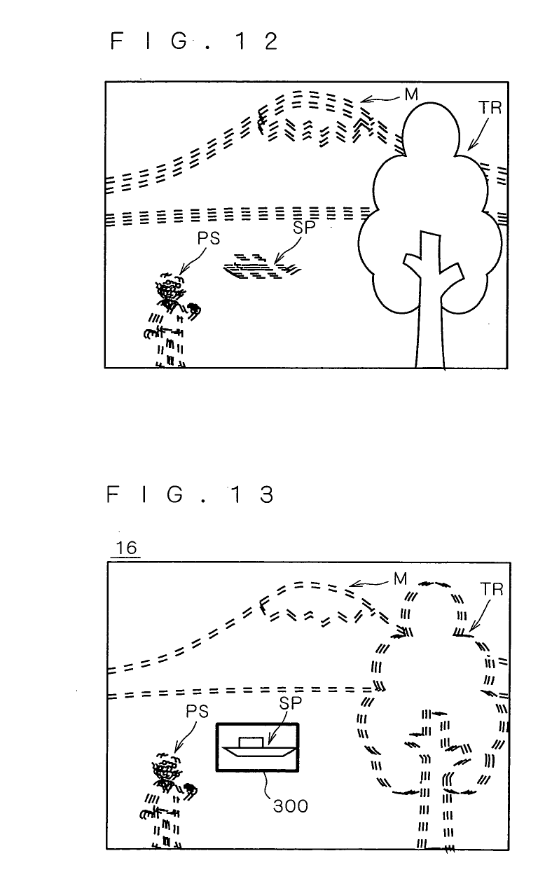

Examples of the plurality of images acquired during this actual photographing operation and temporarily stored in the memory 23 are shown in FIGS. 8 through 12. FIGS. 8 through 12 show the five images in which a mountain M, a ship SP, a person PS and a tree TR in descending order of distance are in-focus subjects. Specifically, a distant landscape such as the mountain M is the in-focus subject in the images shown in FIGS. 8 and 9. The ship SP is the in-focus subject in the image shown in FIG. 10. The person PS is the in-focus subject in the image shown in FIG. 11. The tree TR is the in-focus subject in the image shown in FIG. 12.

In this manner, the photographing operation is carried out wherein the plurality of images corresponding to the respective photographing conditions are acquired while the plurality of photographing conditions regarding “focusing” are successively adopted in time sequence. Then, the actual photographing operation including the exposures, image signal readings and the like in the imaging device 21 is completed.

Referring again to the flow chart of FIG. 5, description will be continued.

When the processing proceeds from Step S16 to Step S18, the actual photographing operation is completed, and the storage processing operation starts. To this end, the rate (frame rate) at which the image signal is read from the imaging device 21 is changed from 300 frames per second (300 fps) to 30 frames per second (30 fps) in Step S18. Then, the processing proceeds to Step S19. Thus, in response to the completion of the actual photographing operation, the frame rate of the imaging device 21 is changed back to the same frame rate as the frame rate (30 fps) used prior to the issue of the photographing start instruction or prior to the start of the actual photographing operation.

In Step S19, a determination is made as to whether or not the evaluation area has been specified based on the manipulation of the user.

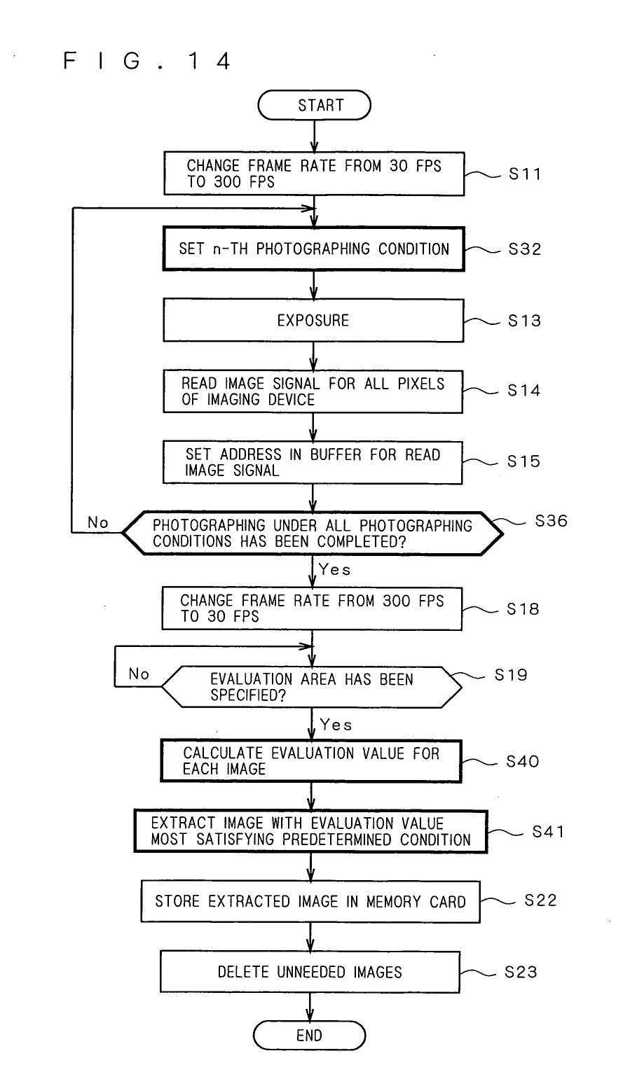

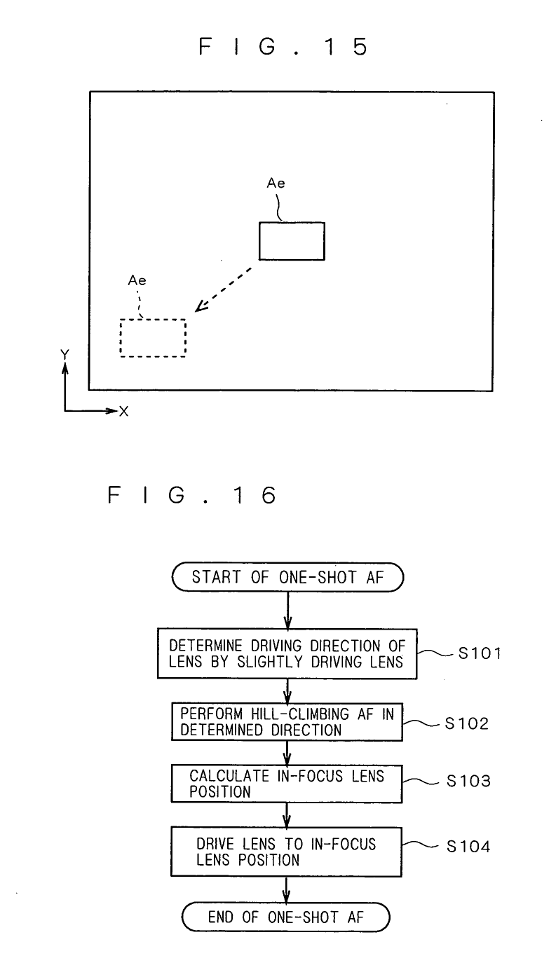

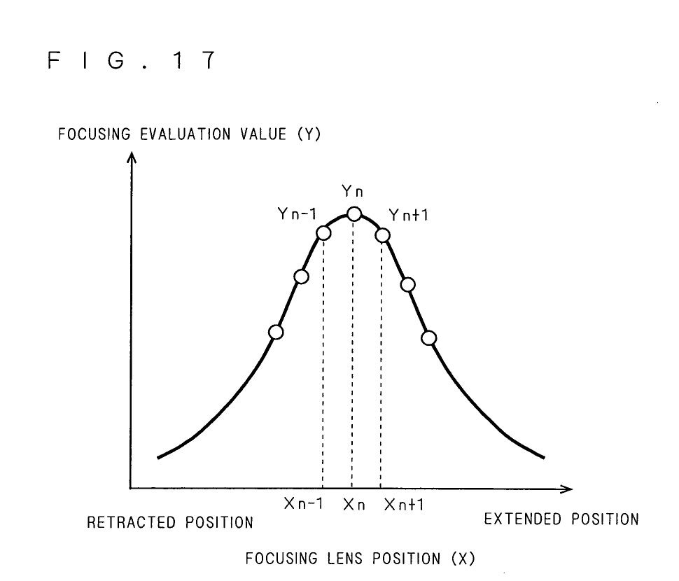

FIG. 13 illustrates a screen (also referred to as an “evaluation area specification screen”) for the specification of the evaluation area. At the time the processing proceeds to Step S19, the evaluation area specification screen is displayed on the LCD 16. A typical image acquired when the focusing lens system 112 is substantially in the midpoint between the distal and proximal positions thereof among the plurality of images temporarily stored in the memory 23 during the actual photographing operation, and a box 300 indicating the position of the evaluation area are displayed in superimposed relation on the evaluation area specification screen. With the evaluation area specification screen displayed on the LCD 16, the user can place the box 300 at the position of the subject desired to be in focus in the typical image by pressing the cross switch 171 as appropriate. In FIG. 13, the box 300 is shown as placed at the position of the ship SP. With the box 300 placed at the position of the desired subject, the user can specify the position of the evaluation area by pressing the execution button 172. The position of the evaluation area specified by the user is stored in the RAM 202. Thus, the position of the common evaluation area is determined for the n images, i.e. n frames, temporarily stored in the memory 23.

The determination in Step S19 is repeated until the evaluation area is specified. After the evaluation area is specified, the processing proceeds to Step S20.

In Step S20, the focusing evaluation value is calculated for the specified evaluation area in each of the n images or n frames temporarily stored in the memory 23. Then, the processing proceeds to Step S21.

In Step S21, an image having the maximum focusing evaluation value is extracted from among the n images or n frames temporarily stored in the memory 23, based on the focusing evaluation values calculated in Step S20. Then, the processing proceeds to Step S22. Specifically, the most in-focus condition of the subject contained in the evaluation area is set in this case as the appropriate condition regarding “focusing,” and the image having the maximum focusing evaluation value is extracted as an image (in-focus image) most satisfying the appropriate condition.

In Step S22, the in-focus image extracted in Step S21 is stored in the memory card 9. Then, the processing proceeds to Step S23. The format of image data stored in the memory card 9 in Step S22 may be selected from among a variety of formats such as RAW, TIFF and JPEG. The in-focus image stored in the memory card 9 may be subjected to a compression process with a predetermined compression ratio in Step S22.

In Step S23, the remainder of the n images or n frames temporarily stored in the memory 23 which are not extracted in Step S21 are deleted as unneeded images from the memory 23. Thus, the storage processing operation is completed, and the operational flow shown in FIG. 5 is completed.

As described above, the image capturing apparatus 1 set in the photographing condition specification mode performs the actual photographing operation in which, for example, the plurality of images corresponding to the respective positions of the focusing lens system 112 are acquired in time sequence. When the user specifies the evaluation area after the actual photographing operation, the in-focus image having the maximum focusing evaluation value for the evaluation area is automatically extracted from among the plurality of images acquired during the actual photographing operation and stored in the memory card 9. The remaining images are deleted. Such operations eliminate the need for complicated manipulations including the setting of the evaluation area prior to photographing and the like, and easily provide the desired in-focus image in which a desired subject is in focus. Thus, the user can concentrate on photographing to acquire the plurality of images without the need to turn his/her mind to the setting for moving the evaluation area to the subject desired to be in focus during the photographing, and then specify the position of the subject desired to be in focus. This reduces mistakes in photographing, and improves the ease-of-use of the image capturing apparatus.

<Operational Flow for Exposure and White Balance Selected as Variable Condition Items>

Although only “focusing” is selected as the variable condition item in the above description for simplicity of discussion, the operational flow in the case where other photographing condition items are selected as the variable condition items will be described below.

FIG. 14 is an operational flow chart illustrating the actual photographing and storage process of the image capturing apparatus 1 in the case where one of the photographing condition items “exposure” and “white balance” is selected as the variable condition item. Because this operational flow includes many process steps similar to those in the flow chart shown in FIG. 5, same reference characters are used to designate the process steps similar to those of FIG. 5. Like the operational flow shown in FIG. 5, the operational flow shown in FIG. 14 is implemented also under the control of the controller 20.

As described above, when the user presses the shutter release button 13 into the half pressed position (S1) with the live view display produced on the LCD 16 after the selection of the variable condition item (one of the items “exposure” and “white balance”) on the selection screen as shown in FIG. 4, typical AF control (e.g., an one-shot AF operation) is effected. If “exposure” is not selected as the variable condition item in this case, the exposure control value for the actual photographing is set based on a live view image. If “white balance” is not selected as the variable condition item in this case, the WB gain value for the actual photographing is set based on a live view image. Subsequently, when the shutter release button 13 is pressed into the fully pressed position (S2), the operational flow shown in FIG. 14 starts, and the processing proceeds to Step S11 of FIG. 14. In Step S11, the frame rate is changed from 30 frames per second (30 fps) to 300 frames per second (300 fps). Then, the processing proceeds to Step S32.

In Step S32, an n-th photographing condition (where n is a positive integer) is set among the plurality of photographing conditions established in accordance with the selection of the variable condition item. Then, the processing proceeds to Step S13. The first one of the plurality of photographing conditions is set for the first execution of Step S32, and the n-th one of the plurality of photographing conditions is set for the n-th execution of Step S32. Because “focusing” is not selected as the variable condition item in this case, the position of the focusing lens system 112 during the actual photographing operation is maintained at a fixed position set by the AF operation performed immediately before the actual photographing operation (when the shutter release button 13 is in the half pressed position (S1)). If “exposure” is not selected as the variable condition item in this case, the exposure control value during the actual photographing operation is a constant value set immediately before the actual photographing operation (when the shutter release button 13 is in the half pressed position (S1)). If “white balance” is not selected as the variable condition item in this case, the WB gain value during the actual photographing operation is a constant value set immediately before the actual photographing operation (when the shutter release button 13 is in the half pressed position (S1)).

Subsequently, an exposure is performed for image-forming a subject on the imaging device 21 (in Step S13). An image signal for all pixels is read from the imaging device 21 and then temporarily stored in the memory 23 (in Step S14). An address in the buffer is set (in Step S15). Then, the processing proceeds to Step S36.

In Step S36, a determination is made as to whether or not photographing has been completed under all photographing conditions regarding the variable condition item. If photographing has not yet been completed under all photographing conditions in Step S36, the processing returns to Step S32, and the processes in Steps S32, S13, S14, S15 and S36 are repeated until photographing are completed under all photographing conditions. If photographing has already been completed under all photographing conditions, the processing proceeds to Step S18. In other words, the photographing operation is carried out wherein the plurality of images corresponding to the respective photographing conditions are acquired while the plurality of photographing conditions regarding each variable condition item are successively adopted in time sequence. Then, the actual photographing operation including the exposures, image signal readings and the like in the imaging device 21 is completed.

The rate (frame rate) at which the image signal is read from the imaging device 21 is changed from 300 frames per second (300 fps) to 30 frames per second (30 fps) in Step S18. Then, the processing proceeds to Step S19.

In Step S19, a determination is made as to whether or not the evaluation area has been specified based on the manipulation of the user. At the time the processing proceeds to Step S19, the evaluation area specification screen as shown in FIG. 13 is also displayed on the LCD 16, as described above. A typical one of the images acquired by repeating the processes in Steps S32, S13, S14, S15 and S36 is displayed on the evaluation area specification screen in this case. With the evaluation area specification screen displayed on the LCD 16, the user can specify the position of the evaluation area by manipulating or pressing the rear manipulation part 17. In this case, the determination in step S19 is repeated until the evaluation area is specified. After the evaluation area is specified, the processing proceeds to Step S40.

In Step S40, the evaluation value (the exposure evaluation value or the WB evaluation value) is calculated for the specified evaluation area in each of the n images or n frames temporarily stored in the memory 23 by repeating the processes in Steps S32, S13, S14, S15 and S36. Then, the processing proceeds to Step S41.

In Step S41, the closest evaluation value to a reference evaluation value established for each variable condition item is detected based on the evaluation values (the exposure evaluation values or the WB evaluation values) calculated in Step S40. Then, an image having the detected evaluation value is extracted from among the n images or n frames temporarily stored in the memory 23. Then, the processing proceeds to Step S22.

The reference evaluation value for “exposure” is an exposure evaluation value such that the exposure value for the subject contained in the evaluation area is moderate or such that the subject contained in the evaluation area is neither too dark nor too bright. The reference evaluation value for “white balance” is a WB evaluation value such that the white balance for the subject contained in the evaluation area is moderate or such that the subject contained in the evaluation area is neither reddish nor bluish. These reference evaluation values are previously stored in the ROM 201 or the like.

Thus, the single image in which the subject contained in the evaluation area has a natural-looking (moderate) brightness or white balance is extracted in Step S41 from among the n images or n frames temporarily stored in the memory 23. In other words, the most natural-looking (moderate) brightness or white balance of the subject contained in the evaluation area is set as the appropriate condition regarding “exposure” or “white balance,” and the image having the calculated exposure evaluation value or WB evaluation value closest to the reference evaluation value corresponding to the appropriate condition is extracted as the single image that most satisfies the appropriate condition.

Thereafter, the image extracted in Step S41 is stored in the memory card 9 (in Step S22). The remainder of the n images or n frames temporarily stored in the memory 23 which are not extracted in Step S41 are deleted as unneeded images from the memory 23 (in Step S23). Thus, the storage processing operation is completed, and the operational flow shown in FIG. 14 is completed.

Although only one photographing condition item is selected as the variable condition item in the above description, the image capturing apparatus 1 is capable of selecting two or more photographing condition items as the variable condition items. When, for example, two variable condition items are selected, the image capturing apparatus 1 can provide stepwise different photographing conditions regarding each of the two variable condition items to perform photographing under a plurality of photographing conditions which are all possible combinations of the conditions of one of the two variable condition items and the conditions of the other variable condition item, and then extract the single image that most satisfies a predetermined condition regarding the two photographing condition items for the evaluation area specified by the user after the actual photographing. Thus, the user can select at least one item from among “focusing,” “exposure” and “white balance” as the variable condition item.

As described hereinabove, the image capturing apparatus 1 according to the preferred embodiment of the present invention, when in the photographing condition specification mode, performs the actual photographing operation to acquire the plurality of images corresponding to the respective stepwise different photographing conditions regarding the variable condition item in time sequence. After the actual photographing operation, the image capturing apparatus 1 extracts the single one of the plurality of images which most satisfies the appropriate condition regarding the variable condition item for the evaluation area specified in accordance with the manipulation of the user. Such an arrangement eliminates the need for the complicated manipulations prior to photographing, and easily provides a desired image. In other words, the user need not turn his/her mind to the setting of the photographing conditions during the photographing, and can make specifications relating to the photographing conditions after the photographing. This reduces mistakes in photographing, and improves the ease-of-use of the image capturing apparatus.

Additionally, the photographing condition item (variable condition item) regarding which the conditions can be varied includes at least one of the photographing condition items: focusing, exposure and white balance. At least one evaluation value is calculated among the focusing evaluation value, the exposure evaluation value and the white balance evaluation value for the evaluation area in each of the plurality of images corresponding to the respective stepwise different photographing conditions regarding the variable condition item. The single image is extracted from among the plurality of images, based on the calculated evaluation value. As a result, the image capturing apparatus 1 can easily acquire a high-quality image satisfying a desired condition about focusing, exposure, white balance, and the like.

Further, the remainder of the plurality of images which are not extracted are deleted from the memory 23 in the photographing condition specification mode. As a result, the image capturing apparatus 1 can make effective use of the storage capacity of the memory card 9. Additionally, the user can easily search the memory card 9 for an acquired desired image.

In the actual photographing operation in the photographing condition specification mode, the image capturing apparatus 1 acquires the plurality of images at the frame rate relatively higher than the frame rate at which the live view images are displayed. This allows the easy acquisition of the plurality of images within substantially the same composition while changing the photographing conditions, thereby to increase the probability of acquisition of a desired high-quality image.

In the photographing condition specification mode, the rate (frame rate) at which the image signal is read from the imaging device 21 is increased in response to the photographing start instruction. Such an arrangement allows the use of the higher frame rate when a plurality of images are required to be acquired within substantially the same composition while changing the photographing conditions, thereby to suppress unwanted power consumption. Moreover, in the photographing condition specification mode, the rate (frame rate) at which the image signal is read from the imaging device 21 is changed back to the frame rate used prior to the issue of the photographing start instruction, in response to the completion of the actual photographing operation. As a result, the use of the higher frame rate only during the actual photographing further suppresses unwanted power consumption.

<Modifications>

Although the preferred embodiment of the present invention has been described above, the present invention is not limited to the specific form described above.

In the photographing condition specification mode according to the above-mentioned preferred embodiment, for example, the single image that most satisfies the appropriate condition regarding the variable condition item is extracted from among the plurality of images temporarily stored in the memory 23, and is stored in the memory card 9 whereas the remaining images not extracted are deleted from the memory 23. The present invention is not limited to this, but the following modification may be made. The image extracted as most satisfying the appropriate condition regarding the variable condition item is subjected to a compression process with a predetermined compression ratio whereas the remaining images not extracted are subjected to a compression process with a compression ratio relatively higher than the predetermined compression ratio, whereby all of the plurality of images are stored in the memory card 9. With such an arrangement, if after the storage process the user does not feel satisfaction with the position of the subject desired to be in focus or to be proper in brightness or in white balance, other images cover the dissatisfaction because the images captured under other photographing conditions are also stored in the memory card 9.

For achievement of both of the effective use of the storage capacity of the memory card 9 and the reliable acquisition of a desired image, the remaining images not extracted, therefore, may be either deleted or subjected to the compression process and the like with a relatively higher compression ratio than the predetermined compression ratio used for the extracted image. In other words, the image capturing apparatus 1 may perform the image processing including the compression process and the deletion process on some or all of the plurality of images temporarily stored in the memory 23 so that each of the images not extracted is relatively lower in data capacity than the extracted image, and then perform the storage process for storing the image data resulting from the image processing in the memory card 9. The term “relatively lower in data capacity” not only means the mere decrease in data capacity caused by the increase in compression ratio and the like, but also is meant to include the data capacity equaling zero caused by the data deletion.

However, if the user places greater importance on the effective use of the storage capacity of the memory card 9, it is more preferable to delete the remaining images not extracted.

Although the acquisition of one still image is described in the above-mentioned preferred embodiment, the present invention is not limited to such a specific form, but may be applied to the capturing of a moving image. Specifically, repeating the operation of acquiring the plurality of images corresponding to the respective stepwise different photographing conditions regarding the variable condition item in time sequence provides a plurality of moving images corresponding to the respective stepwise different photographing conditions regarding the variable condition item. After the acquisition of the plurality of moving images, the image capturing apparatus 1 can extract the single one of the plurality of moving images which most satisfies the appropriate condition regarding the variable condition item for the evaluation area specified in accordance with the manipulation of the user. This provides the moving image composed of only images in which a desired subject is in focus or images captured under the desired exposure and white balance conditions and the like. In this modification, the moving image displayed on the LCD 16 during the playback of the moving image is composed of still images updated, for example, every 1/30 of a second. During the capturing of the moving image, on the other hand, the imaging device 21 outputs an image signal at a frame rate (e.g., 300 frames per second) relatively higher than the frame rate used during the display of the moving image.

Thus, for moving image capturing, the image capturing apparatus 1 can capture the images at the higher frame rate than the frame rate used during the image display while changing the photographing conditions as appropriate to extract a desired one of the plurality of images obtained within a period of time corresponding to a time interval at which the images are updated during the display of the moving image, thereby achieving the smooth moving image.

Although the box 300 is used to specify the position of the evaluation area in the above-mentioned preferred embodiment, the present invention is not limited to such a specific form. For example, a pointer may be used to specify a point on an image so as to specify the evaluation area including the specified point.

While the invention has been described in detail, the foregoing description is in all aspects illustrative and not restrictive. It is understood that numerous other modifications and variations can be devised without departing from the scope of the invention.

What is claimed is:

1. An image capturing apparatus comprising:
an imaging part for acquiring an image of a subject;
a photographing control part for causing said imaging part to perform a photographing operation for acquiring a plurality of images corresponding to a plurality of photographing conditions, respectively, while successively adopting the plurality of photographing conditions in time sequence, said plurality of photographing conditions being stepwise different from each other regarding a predetermined photographing condition item;
a specification part for specifying a position of an evaluation area for said plurality of images in response to a manipulation of a user after said photographing operation; and
an extraction part for extracting one of said plurality of images which most satisfies a predetermined condition regarding said predetermined photographing condition item for said evaluation area.

2. The image capturing apparatus according to claim 1, wherein
said predetermined photographing condition item includes at least one item among focusing, exposure and white balance, and
said extraction part includes
an evaluation value calculation part for calculating at least one evaluation value for said evaluation area among a focusing evaluation value, an exposure evaluation value and a white balance evaluation value for said evaluation area in each of said plurality of images, and
a part for extracting said one of said plurality of images, based on said evaluation value calculated by said evaluation value calculation part.

3. The image capturing apparatus according to claim 1, further comprising
a deletion part for deleting the remainder of said plurality of images not extracted by said extraction part.

4. The image capturing apparatus according to claim 1, wherein
said photographing control part drives said imaging part at a frame rate relatively higher than a frame rate for use during image display to cause said imaging part to acquire said plurality of images.

5. The image capturing apparatus according to claim 1, further comprising:
an instruction part for issuing a start instruction of said photographing operation; and
a change part for changing a frame rate in said imaging part to a relatively higher frame rate than a frame rate used prior to the issue of said start instruction in response to said start instruction.

6. The image capturing apparatus according to claim 5, wherein
said change part changes the frame rate in said imaging part to the frame rate used prior to the issue of said start instruction in response to the completion of said photographing operation.

7. A method of acquiring an image, comprising the steps of:
(a) causing a predetermined imaging part to perform a photographing operation for acquiring a plurality of images corresponding to a plurality of photographing conditions, respectively, while successively adopting the plurality of photographing conditions in time sequence, said plurality of photographing conditions being stepwise different from each other regarding a predetermined photographing condition item;
(b) specifying a position of an evaluation area for said plurality of images in response to a manipulation of a user after said photographing operation; and
(c) extracting one of said plurality of images which most satisfies a predetermined condition regarding said predetermined photographing condition item for said evaluation area.

8. An image capturing apparatus comprising:
an imaging part for acquiring an image of a subject;
a specification part for specifying a position of an evaluation area for a plurality of images in response to a manipulation of a user after a photographing operation of said imaging part for acquiring said plurality of images; and
an extraction part for extracting one of said plurality of images which most satisfies a predetermined condition regarding a predetermined photographing condition item for said evaluation area.

9. The image capturing apparatus according to claim 8, further comprising
a photographing control part for causing said imaging part to perform said photographing operation for acquiring said plurality of images corresponding to a plurality of photographing conditions, respectively, while successively adopting the plurality of photographing conditions in time sequence, said plurality of photographing conditions being stepwise different from each other regarding said predetermined photographing condition item.

10. The image capturing apparatus according to claim 9, wherein
said predetermined photographing condition item includes at least one item among focusing, exposure and white balance, and
said extraction part includes
an evaluation value calculation part for calculating at least one evaluation value for said evaluation area among a focusing evaluation value, an exposure evaluation value and a white balance evaluation value for said evaluation area in each of said plurality of images, and
a part for extracting said one of said plurality of images, based on said evaluation value calculated by said evaluation value calculation part.

11. The image capturing apparatus according to claim 8, further comprising
a deletion part for deleting the remainder of said plurality of images not extracted by said extraction part.

12. The image capturing apparatus according to claim 9, wherein
said photographing control part drives said imaging part at a frame rate relatively higher than a frame rate for use during image display to cause said imaging part to acquire said plurality of images.

13. The image capturing apparatus according to claim 9, further comprising:
an instruction part for issuing a start instruction of said photographing operation; and
a change part for changing a frame rate in said imaging part to a relatively higher frame rate than a frame rate used prior to the issue of said start instruction in response to said start instruction.

14. The image capturing apparatus according to claim 13, wherein
said change part changes the frame rate in said imaging part to the frame rate used prior to the issue of said start instruction in response to the completion of said photographing operation.
